(19) United States
(12) Patent Application Publication
(10) Pub. No.: US 2003/0031342 A1
(43) Pub. Date: Feb. 13, 2003

(54) Apparatus for examining documents of value

(76) Inventors: Markus Sperl, Munchen (DE); Achim Philipp, Kolbermoor (DE)

Correspondence Address: BACON & THOMAS, PLLC, 625 SLATERS LANE, FOURTH FLOOR, ALEXANDRIA, VA, 22314

(21) Appl. No.: 10/206,236

(22) Filed: Jul. 29, 2002

(30) Foreign Application Priority Data
Jul. 31, 2001 (DE) 101 37 043.1

(51) Int. Cl. G06K 9/00

(52) U.S. Cl. 382/100

(57) ABSTRACT

The invention relates to an apparatus for examining documents of value, in particular bank notes, with one or more light-emitting diodes (10) for illuminating a document of value (1) under examination with light emitted by the light-emitting diodes (10) and at least one detector device (30) for detecting light (31) emanating from the document of value (1).

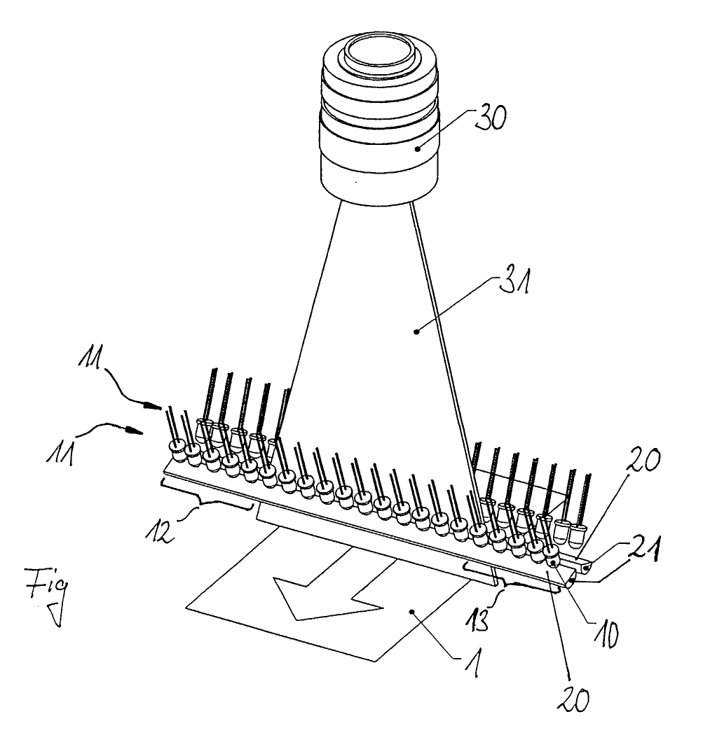

For improved illumination of the documents of value under examination (1) along with a simple structure, it is provided that the light-emitting diodes (10) are formed to emit white light. This obtains uniform spatial and spectral illumination of the document of value (1).

This invention relates to an apparatus for examining documents of value, in particular bank notes, with one or more light-emitting diodes for illuminating a document of value under examination with light emitted by the light-emitting diodes and at least one detector device for detecting light emanating from the document of value.

Apparatuses of this type are used for, among other things, machine processing of bank notes in bank note processing machines. Depending on the manner of illumination of the bank note under examination and/or of evaluation of the light reflected, in particular diffusely reflected, and/or transmitted by the bank note and detected by the detector device, statements can be derived from the detected light about the examined bank note, for example its value, authenticity or degree of soiling.

With sensors of this type known from the prior art, the bank notes are illuminated using e.g. light-emitting diodes of different colors. A detector sensitive in the corresponding color ranges detects the light reflected by the bank note.

For reliable optical examination of bank notes with apparatuses known from the prior art, a plurality of light-emitting diodes each emitting light of a different color are therefore usually required. This can result in the different-colored light emitted by the various light-emitting diodes hitting the bank note at different places. Light detected from the different places on the bank note therefore generally has a different color composition due to the illumination. For reliable testing and processing of bank notes, in particular when examining the soiling or detecting the serial number of a bank note, however, uniform spatial and spectral illumination of the bank note is desirable.

It is the problem of the invention to state an apparatus for examining documents of value that has a simple structure and permits improved illumination of the documents of value under examination.

The problem is solved according to claim 1 if the light-emitting diodes used for illuminating the document of value under examination are formed to emit white light.

White light refers within the scope of the invention to any type of light perceived as substantially white light by the human eye. This is light with a spectral intensity distribution that extends substantially over a wavelength region between about 400 and 700 nanometers and preferably has a continuous course in this wavelength region. Light-emitting diodes refer within the scope of the invention to all types of light-emitting diodes, in particular based on semiconductors or organic polymers, that produce light during operation in the forward direction.

The use of white light-emitting diodes obtains improved spectral illumination of the document of value under examination since every illuminated place on the document of value is illuminated at a broad bandwidth with white light.

The individual light-emitting diodes are preferably each formed to produce light with at least two different spectral intensity distributions, the spectral intensity distributions mixing to form white light. In particular, the spectral intensity distributions are in the red, green and blue spectral regions. Such light-emitting diodes can be realized for example by a combination of semiconductor crystals or luminous organic polymers having different band gaps, so that the energy, and thus the spectral intensity distribution, of the particular emitted light is in different wavelength regions. Additive color mixture of the different spectral intensity distributions results in white light. White light-emitting diodes of this type have the advantage of very high long-term stability and therefore allow stable illumination. This guarantees reliable examination of documents of value.

In an alternative embodiment it is provided that at least one light-emitting diode is formed to produce light with a spectral intensity distribution in the blue spectral region. Additionally, a converting material is provided for absorbing at least part of the produced blue light and converting it into longer-wave light, in particular yellow light. The unabsorbed part of the blue light then mixes with the converted longer-wave light to form white light. The converting material can be provided for example in the form of a foil disposed in front of light-emitting diodes 10. This functional principle corresponds to that of fluorescent tubes and is a simple and cost-effective alternative to the above-described light-emitting diodes, depending on the requirements.

A further aspect of the invention is that at least one optical device is provided that is formed to spatially homogenize the light emitted by the individual light-emitting diodes. Spatial homogenization refers here to any way of smoothing spatial intensity fluctuations coming from the light-emitting diodes each with approximately punctiform emission. The obtained illumination of the document of value is thus especially homogeneous, i.e. poor in spatial intensity fluctuations. This is of advantage especially when a contiguous area, e.g. a strip-shaped area or a certain surface area, is to be illuminated on the bank note.

The invention will be explained in more detail in the following with reference to an example shown in a FIGURE.

In the example shown in the FIGURE, white light-emitting diodes 10 are disposed in rows 11 along two straight paths. Depending on the application, it is possible to dispose light-emitting diodes 10 in different-shaped rows, for example circular or semicircular rows. Disposing light-emitting diodes 10 in rows 11 obtains high spatial homogeneity of the illumination of document of value 1 since parts of the light emitted by adjacent light-emitting diodes 10 overlap. Use of white light-emitting diodes 10 in addition guarantees uniform spectral illumination of document of value 1. The spectral composition of the broad-band white light therefore does not vary, or at least not essentially vary, across the illuminated area of document of value 1.

Light-emitting diodes 10 are preferably mounted on a common carrier, omitted in the drawing for reasons of clarity. In particular, a separate carrier is provided for each row 11. The carrier may be an accordingly suitable board on which individual light-emitting diodes 10 are mounted. Light-emitting diodes 10 are preferably designed so as to be applicable to the surface of the board directly, i.e. without any prebored holding holes or bases. Such light-emitting diodes are also called SMD (surface mounted device) light-emitting diodes. This method allows very fast and cost-effective production of the described illumination device.

A further possibility is to provide light-emitting diodes 10 with a casting compound after their application to a board. This technology is also called COB (chip on board) technology. The casting compound protects light-emitting diodes 10 especially especially well from moisture, soiling and mechanical disturbances. In addition, the casting compound can have a converting material admixed thereto that is formed to convert light into longer-wave light and then applied directly over the light-emitting diodes during casting. This permits especially simple realization of the above-described alternative embodiment wherein the light-emitting diodes emit blue light that is partly converted by a converting material into yellow light, the latter mixing with the remaining blue light to form white light.

For further improving the spatial homogeneity of light emitted by light-emitting diodes 10 disposed in rows 11, it is advantageous to dispose light-emitting diodes 10 closer together in the area of one or both ends 12, 13 of row 11 than in the other areas of row 11. This obtains high spatial homogeneity of the emitted light toward edge area 12, 13 of row 11, thereby guaranteeing uniform illumination of document of value 1.

For selectively illuminating individual areas of document of value 1 with a certain intensity and/or extension, light-emitting diodes 10 are formed to emit light within a certain angle range, the angle range having a size between 10° and 60°. The choice of the size of the angle range, which is also called the angle of radiation, can be used to adjust the spatial intensity distribution on document of value 1 to be illuminated. A small angle of radiation results in stronger focusing of light and thus brighter illumination of document of value 1. This simultaneously permits a greater distance between light-emitting diodes 10 and document of value 1. In contrast, greater angles of radiation are suitable for illuminating greater areas at simultaneously smaller distances between light-emitting diodes 10 and document of value 1. At greater angles of radiation, i.e. between about 30° and 60°, there is furthermore a great overlap of radiated light from individual light-emitting diodes 10 disposed side by side, so that this likewise obtains spatial homogenization of light emitted by individual light-emitting diodes 10.

In the shown example, each row 11 of light-emitting diodes 10 has disposed therebefore rod-shaped lens 20 that is formed for aspheric, i.e. non-punctiform, imaging, in particular focusing, of light emitted by light-emitting diodes 10 on document of document of value 1. Bases 21 of rod-shaped lenses 20 preferably each have a shape corresponding to a part of a conic section, i.e. a circle, parabola, ellipse or hyperbola.

Depending on base 21 of rod-shaped lens 20, a focusing of emitted light or an areal illumination of document of value 1 can be adjusted. The aspheric imaging of light emitted by individual light-emitting diodes 10 on document of value 1 and the resulting overlap of light emitted by adjacent light-emitting diodes obtains a smoothing of the intensity distribution varying spatially along rows 11.

In an especially preferred embodiment of the invention, rod-shaped lens 20 has aspheric base 21. An aspheric base refers here to any area with a shape differing from a circle or sector. For example, an aspheric base can have different radii of curvature in different sectors of the base. With this type of rod lens a blurred focus or focal line can be selectively adjusted. This provides illumination that is largely independent of the distance between light-emitting diodes 10 and document of value 1. This is of advantage particularly for use of the inventive apparatus in bank note processing machines since these generally transport bank notes past the sensor system at great transport speeds, usually resulting in distance variation of illumination intensity caused by fluttering of the notes. Use of the described rod lenses greatly reduces such intensity variations so as to guarantee homogeneous and constant illumination of bank notes.

As an alternative to rod-shaped lenses 20, trough-shaped mirrors (not shown) are suitable for aspheric imaging of light by emitted light-emitting diodes 10 on document of value 1. Analogously to above-described rod-shaped lenses 20, the shape of the base of the mirrors can be used to adjust the type of imaging, in particular focusing, of light emitted by light-emitting diodes 10 on document of value 1.

As an alternative or in addition to the use of rod-shaped lenses 20 or trough-shaped mirrors, an optical device can be provided for diffusely scattering light emitted by light-emitting diodes 10. This may preferably be a diffusing disk that diffusely scatters light passing therethrough, or a diffusely scattering mirror. This permits realization of a very simple, robust and cost-effective way of spatially homogenizing white light emitted by the individual light-emitting diodes.

White light hitting document of value 1 is reflected, in particular diffusely reflected, thereby and detected by detector device 30. The path of light from the document of value to detector device 30 is shown schematically by beam path 31. Embodiments of the shown apparatus are of course also possible in which light transmitted by document of value 1 is detected in addition or as an alternative to reflected light 31. Detector device 30 or an additional detector device (not shown) is then to be disposed accordingly on the other side of document of value 1.

Also, white light of light-emitting diodes 10 can excite documents of value 1, which for example contain luminescent substances in the paper and/or ink, to emit luminescence light, in particular fluorescence or phosphorescence light. Luminescence light emanating from document of value 1 is then detected by detector device 30.

Detector device 30 can be for example a device for spatially resolved detection of reflected light 31. This is of importance in particular when the nature, spatial extent and/or position of optical features, such as serial numbers, or other optically recognizable areas, such as defects or dirty spots, are to be detected.

It is fundamentally also possible to provide detector device 30 for integral detection of light 31 reflected by a certain area of document of value 1.

Detector device 30 generally includes optoelectric converter elements for converting detected light into electric signals. The converter elements are preferably sensitive in the total spectral region of the white light emitted by light-emitting diodes 10. It is fundamentally also possible, however, to provide different converter elements that are each sensitive only in certain spectral regions, for example the red, green or blue spectral region.

Suitable converter elements for spatially resolved detection of light are for example charge-coupled detector arrays, so-called CCD arrays, or photodiode arrays. For integral detection of light, individual photodiodes are suitable for example.

The shown example is particularly suitable for spatially homogeneous, strip-shaped illumination of documents of value with white light. At the same time, the sim-simple and space-saving structure permits compact integration in corresponding machines for automatic processing of documents of value, such as bank note processing machines.

1. An apparatus for examining documents of value, in particular bank notes, with one or more light-emitting diodes (10) for illuminating a document of value (1) under examination with light emitted by the light-emitting diodes (10) and at least one detector device (30) for detecting light (31) emanating from the document of value (1), characterized in that the light-emitting diodes (10) are formed to emit white light.

2. An apparatus according to claim 1, characterized in that at least one light-emitting diode (10) is formed to produce light with at least two different spectral intensity distributions and the spectral intensity distributions mix to form white light.

3. An apparatus according to either of claims 1 and 2, characterized in that at least one light-emitting diode (10) is formed to produce light with spectral intensity distributions in the red, green and blue spectral regions and the spectral intensity distributions in the red, green and blue spectral regions mix to form white light.

4. An apparatus according to any of claims 1 to 3, characterized in that at least one light-emitting diode (10) is formed to produce blue light with a spectral intensity distribution in the blue spectral region and a converting material is provided for converting at least a first part of the produced blue light into longer-wave light, in particular yellow light, a second part of the blue light and the longer-wave light mixing to form white light.

5. An apparatus according to any of claims 1 to 4, characterized in that the light-emitting diodes (10) are disposed in a row (11), in particular on a straight path.

6. An apparatus according to claim 5, characterized in that the light-emitting diodes (10) are disposed closer together in the area of one end (12 or 13) or in the area of both ends (12 and 13) of the row (11) than in other areas of the row (11).

7. An apparatus according to any of claims 1 to 6, characterized in that the light-emitting diodes (10) are formed to emit light within a certain angle range, the angle range having a size between 10 degrees and 60 degrees.

8. An apparatus according to any of claims 1 to 7, characterized in that at least one optical device (20) is provided that is formed to spatially homogenize light emitted by the light-emitting diodes (10).

9. An apparatus according to claim 8, characterized in that the optical device is formed for aspheric imaging of light emitted by the light-emitting diodes (10) on the document of value (1).

10. An apparatus according to either of claims 8 and 9, characterized in that the optical device is formed as a trough-shaped mirror or a rod-shaped lens (20).

11. An apparatus according to claim 10, characterized in that the trough-shaped mirror or the rod-shaped lens (20) has an aspheric base (21).

12. An apparatus according to either of claims 10 and 11, characterized in that the trough-shaped mirror or the rod-shaped lens (20) has a base (21) corresponding to a part of a conic section, i.e. circle, parabola, ellipse, hyperbola.

13. An apparatus according to any of claims 8 to 12, characterized in that the optical device is formed to diffusely scatter light emitted by the light-emitting diodes (10), in particular as a diffusing disk or diffuse mirror.

14. An apparatus according to any of claims 1 to 13, characterized in that the detector device (30) is formed for spatially resolved detection of light (31) emanating from the document of value (1).

15. An apparatus according to claim 14, characterized in that the detector device is formed as a CCD array or photodiode array.

16. An apparatus according to any of claims 1 to 15, characterized in that the detector device (30) has optoelectric converter elements that are sensitive in the spectral region of the white light (31) emitted by the light-emitting diodes (10).

17. An apparatus according to any of claims 1 to 16, characterized in that the light-emitting diodes (10) are disposed on at least one common carrier, in particular a board.

18. An apparatus according to claim 17, characterized in that the light-emitting diodes (10) are designed as SMD light-emitting diodes that can be applied directly to the carrier.

19. An apparatus according to any of claims 17 to 18, characterized in that the light-emitting diodes (10) applied to the carrier are cast with a casting compound.

20. An apparatus according to any of claims 17 to 19, characterized in that the casting compound contains a converting material that is formed to convert light into longer-wave light.
